(19) United States
(12) Patent Application Publication
(10) Pub. No.: US 2012/0148882 A1
(43) Pub. Date: Jun. 14, 2012

(54) BATTERY

(75) Inventor: Niels Bakker, Hong Kong (CN)

(73) Assignee: Eco Group Asia Limited, Hong Kong (HK)

(21) Appl. No.: 13/346,589

(22) Filed: Jan. 9, 2012

Related U.S. Application Data
(63) Continuation of application No. PCT/CN2011/076696, filed on Jun. 30, 2011.
Application No. PCT/CN2011/076696 is a continuation-in-part of application No. PCT/CN2010/074855, filed on Jun. 30, 2010.

(51) Int. Cl. H01M 6/32

(52) U.S. Cl. 429/52; 429/118

(57) ABSTRACT

A battery including: a metal tube having opposed first and second ends, and an inner peripheral surface defining a chamber in which a liquid-activatable powder mixture is disposed therein; a permeable separator sheet for electrically isolating the powder mixture from the metal tube; a conductive rod having a first end located adjacent the first end of the metal tube and extending to a second end in contact with the powder mixture; and a passage extending between the first and second opposed ends of the metal tube to allow flow of liquid therethrough, wherein said liquid is able to be delivered from the passage into contact with the powder mixture via the permeable separator sheet substantially along the length of the metal tube so as to activate the powder mixture, whereby the activated powder mixture is adapted to generate a potential difference between the conductive rod and the metal tube.

### FIELD OF INVENTION

The present invention relates to the field of reusable batteries and particularly batteries which are activated by addition of a liquid such as water.

### BACKGROUND OF THE INVENTION

The problem with many conventional off-the-shelf type batteries such as AA, AAA, D batteries and the like is that they tend to deteriorate in effectiveness over time during storage. This is particularly problematic when an emergency situation arises and properly functioning batteries are required to power a torch, a radio or other potentially life-saving equipment.

Water-activated batteries have been employed in seeking to address the above problem as they can be stored for a relatively long period of time in an inactive state—that is, when water or a water-based substance has not yet been added to the electrolyte powder mixture. Such batteries can then be activated when required by adding water or a water-based substance for use without substantial loss in performance of the battery.

However, existing water-activated batteries also exhibit certain drawbacks. For instance, in order to add water to an electrolyte powder mixture within the battery to activate the battery, a pipette is typically required to inject water under pressure into the battery casing via a small aperture in an end of the battery. This can be a tedious and messy procedure particularly for young children and if the pipette is inadvertently lost, water cannot be injected into the aperture to properly activate the battery. Moreover, it is difficult to effectively deliver the water into contact with the bulk of the electrolyte powder within the battery due to existing internal battery configurations and this has a detrimental effect upon the electrical performance of the battery.

A further problem associated with current water-activated batteries is that the casing tends to be made from magnesium or other such material which expands and deforms over time during use. When the battery has deformed, it is not only difficult to remove from an electronic device, but it may also damage the electronic device in doing so. Furthermore, current water-activated batteries which use magnesium anodes are prone to deterioration and have a relative short active life-span due to the strong reaction with water or water based substances.

### SUMMARY OF THE INVENTION

The present invention seeks to alleviate at least one of the problems discussed above in relation to the prior art.

The present invention may involve several broad forms. Embodiments of the present invention may include one or any combination of the different broad forms herein described.

In a first broad form, the present invention provides a battery including:

a metal tube having opposed first and second ends, and an inner peripheral surface defining a chamber in which a liquid-activatable powder mixture is disposed therein;

a permeable separator sheet for electrically isolating the powder mixture from the metal tube;

a conductive rod having a first end located adjacent the first end of the metal tube and extending to a second end in contact with the powder mixture; and a passage extending between the first and second opposed ends of the metal tube to allow flow of liquid therethrough, wherein said liquid is able to be delivered from the passage into contact with the powder mixture via the permeable separator sheet substantially along the length of the metal tube so as to activate the powder mixture, whereby the activated powder mixture is adapted to generate a potential difference between the conductive rod and the metal tube.

Preferably, the metal tube may include at least one of zinc, magnesium, aluminium, and a combination thereof. More preferably, the metal tube may include at least 99% zinc. Also preferably, the metal tube may be bathed in a solution of indium to slow down or alleviate corrosion.

Preferably, the first end of the metal tube may be substantially sealed by a first end cap and the second end of the metal tube may be releasably sealable by a second end cap. Preferably, the liquid may be adapted for delivery into the chamber via the second end of the metal tube when released from the second end of the metal tube. Typically the first end cap may include a plastic material and the second end cap may include a metal material such as plated stainless steel which may assist in slowing down or alleviating corrosion.

Preferably, the second end cap and the second end of the metal tube may include substantially similar diameters. Preferably, the second end cap may be adapted for screw-threaded engagement either directly with the second end of the metal tube, or, adapted for screw-threaded engagement with an outer casing surrounding the metal tube so as to allow the second end cap to releasably seal the second end of the metal tube. Also preferably, the second end cap includes a metal material adapted for electrical communication with the metal tube when releasably sealing the second end of the metal tube. Typically, the second end cap may also be in direct physical contact with the metal tube when releasably sealing the second end of the metal tube which may serve as a negative electrode of the battery in use.

Advantageously, a liquid may be delivered into the chamber of the metal tube relatively easily and quickly in order to activate the powder mixture by pouring or otherwise scooping the liquid into the metal tube via the unsealed second end of the metal tube. Preferably, the present invention may be submerged ideally in pure water for a period of time. The convenient ability to open up the second end of the metal tube by removing the releasably sealable second end cap for delivery of liquid therein may also alleviate the additional costs and packaging space associated with certain prior art batteries which require use of a pipette to squirt liquid into the battery via a relatively small aperture in the battery casing. In this regard, the present invention may also be advantageous in that it is possible to more readily determine by visual inspection whether a suitable amount of water has been delivered into the metal tube to activate the battery. In contrast, with certain pre-existing water-activatable batteries it is difficult to accurately determine if a suitable amount of water has been squirted into a battery via an aperture using a pipette because the end caps of the battery are fixed and are not designed to be manually removed by the user to perform a visual inspection. It is only once excess water has leaked out of the aperture in the battery casing that some indication of the amount of water in the battery is evident, however, this is a clumsy and inaccurate procedure. Moreover, the leakage of excess water from out of the aperture may not necessarily provide an accurate indication as to whether a suitable amount of water has been delivered into contact with the powder mixture within the battery to effect proper functioning of the battery.

The use of a metallic second end cap adapted to releasably seal the second end of the metal tube may also be advantageous in that the second end cap may be readily separated from the metal tube by a user for ease of recycling and/or re-usage if required. That is, the need for relatively expensive recycling processes such as metal shredding, furnacing and magnetic separation which is generally required to separate an integrally formed conventional battery may be alleviated due to the fact that the metallic second end cap may be readily separated from the metal tube of the battery. Typically, the metal tube (which may typically be formed from a zinc material) may be relatively easily removed from the outer casing (which may typically be formed from a stainless steel material) in order for the metal tube to be recycled utilising relatively low energy requirements whilst both the outer casing and the releasably sealable second end cap may be re-used in production of new batteries.

Preferably, the first end of the conductive rod may extend outwardly of the first end of the metal tube via an aperture disposed in the first end cap. Preferably, second end of the conductive rod may be substantially embedded within the powder mixture. Typically, the conductive rod may include at least one of a brass, a carbon a stainless steel material and a combination thereof.

Preferably, the passage may extend an entire length of the metal tube. Also preferably, the passage may extend in a substantially straight path between first and second opposed ends of the metal tube. Typically, the passage may extend in a substantially parallel path relative to an elongate axis of the metal tube. More preferably, the passage may include a groove formed in an inner peripheral surface of the metal tube. Typically, a plurality of such grooves may be formed in the inner peripheral surface wall of the metal tube. In preferred embodiments at least six grooves may be formed in the inner peripheral surface. Typically, the plurality of grooves may be evenly spaced apart around the inner peripheral surface. The groove may be etched out of the inner peripheral surface of the metal tube using suitable machinery and known techniques. Alternatively, it is possible for the metal tube to be die-cast with the grooves being formed in the inner peripheral surface during the die-casting process.

Alternatively, the passage may include a curved path which may allow greater exposure to surface area of the permeable separator sheet and/or powder mixture along the length of the metal tube.

Advantageously, the inclusion of the passage, which in preferred embodiments includes at least one groove disposed in the inner peripheral surface of the metal tube, allows a liquid to be delivered into contact more uniformly and evenly across the overall surface area of the powder mixture in the metal tube via the permeable separator sheet. This is due to the liquid being able to flow through the passage substantially along the length of the metal tube.

In contrast, in certain prior art water activatable batteries it is difficult for the water to penetrate through the powder mixture via only the top surface of the powder mixture. Moreover, certain other prior art water-activated batteries include a sponge within the metal tube which upon absorbing water, does not thereafter tend to easily release the absorbed water into contact with the powder mixture. Accordingly, the electrical performance of such prior art batteries tends to be less efficient in comparison to the electrical performance of the present invention.

Preferably, the liquid may include water or any water-based liquid. More preferably, the liquid may include distilled water or pure water. Typically at least approximately 1.7 grams of water may be delivered in to the metal tube of the battery to suitably activate embodiments of the present invention.

Preferably, the present invention may include an outer casing surrounding the metal tube which may be adapted to substantially reinforce the metal tube against deformation due to the effects of heat and the like. In prior art batteries which do not use such an outer casing, the battery may be more susceptible to deformation due to heat which makes it difficult to effect removal of the battery from the battery compartment of an electronic device without causing further damage to the electronic device. Moreover certain prior art batteries do not tend to allow for easy separation of the outer casing from the metal tube and therefore shredding is required during recycling. Typically, the outer casing may include a thickness of between approximately 0.2 to 1 mm and preferably, a thickness of 0.5 mm.

Preferably, when the second end cap releasably seals the second end of the metal tube, the second end cap may be releasably engaged with the outer casing. Also preferably, the second end cap may be releasably engaged with the outer casing by way of screw-threaded engagement. Also preferably, when the second end cap is releasably engaged with the outer casing to releasably seal the second end of the metal tube, the second end cap may be in electrical communication with the metal tube. Alternatively, in certain embodiments the second end cap may be in direct physical contact with the second end of the metal tube when it is releasably engaged to the outer casing.

Typically, the outer casing may include a metal such as stainless steel. Advantageously, in embodiments where the second end cap is releasably engaged with the outer casing, the second end cap may be in electrical communication with the metal tube via the outer casing.

Alternatively, it may be preferable in certain embodiments for the outer casing to include a plastic material. Advantageously, a plastic outer casing may reduce the weight of the battery compared to use of other materials such as metal. This may therefore alleviate transportation costs when shipping large volumes of embodiments of the present invention. The use of a plastic casing may further alleviate potentially short circuiting of the battery where potentially loose powder mixture within the metal tube comes into contact with the outer casing. Furthermore, a plastic outer casing may be relatively easily and cheaply debossed using suitable machinery with commercial indicia and/or be decorated (e.g. using colours) during manufacture for marketing and/or aesthetic purposes if required. Typically, if a plastic outer casing is used, a portion of the plastic casing may be covered in a conductive material in order to provide electrical communication between the second end cap and the metal tube when the second end cap is releasably engaged to the plastic outer casing. Typically the conductive material may cover a screw-thread portion of the plastic outer casing on an inner surface of the outer casing.

Preferably, the powder mixture may include a metal oxide powder. Typically, the metal oxide may include at least one of an activated carbon, manganese dioxide, iron oxide and crystalline silver oxide.

Typically, the electrolyte powder mixture may include particles formed from a mixture of ammonium chloride particles, zinc chloride particles, manganese dioxide particles, acetylene carbon black particles, and zinc oxide particles. More typically, in preferred embodiments, the powder mixture may include approximately 3% ammonium chloride particles, 16% zinc chloride particles, 68% manganese dioxide particles, 12.4% acetylene carbon black and 0.6% zinc oxide particles by percentage weight of the powder mixture.

Typically, the powder mixture may be ball-milled using a rotary or planetary ball mill. Typically the ball mill used to ball mill the powder mixture may include ceramic balls. Typically, powder mixture particles may include diameters in the nanometre to micrometre range. More typically, the powder mixture may include particles having diameters substantially in the nanometre to micrometre range. More typically, the powder mixture particles may include diameters of substantially around 4.32 micrometres.

Preferably, the permeable separator sheet may extend substantially along the length of the inner peripheral surface and lie flush against the inner peripheral surface where it provides physical and electrical separation of the electrolyte power mixture from the inner peripheral surface of the metal tube. Typically, the permeable separator sheet may include at least one of a permeable paper material such as kraft paper, a permeable synthetic polymer material, and a permeable natural polymer material. Preferably, the permeable separator sheet may include a thickness of substantially around 0.08 mm. Also preferably, the permeable separator sheet may include a double-layer of 0.08 mm permeable separator sheets to assist in delivering the liquid into contact with the powder mixture.

Typically, the permeable separator sheet may be preformed or folded to complement the contour of the inner peripheral surface of the metal tube. Preferably, a portion of the permeable separator sheet arranged for positioning adjacent the second end of the metal tube may be adapted for folding over a top region of the powder mixture adjacent the second end of the metal tube to alleviate leakage of loose powder mixture outwardly of the second end of the metal tube.

Preferably, a retaining member may be disposed in the chamber adjacent the second end of the metal tube which abuts against the folded over portion of the permeable separator sheet. Preferably, the retaining member may include at least one aperture to allow fluid communication therethrough from the unsealed second end of the metal tube into contact with the folded over portion of the permeable separator sheet and thereafter into contact with the powder mixture. Typically, a plurality of apertures may be disposed in the retaining member and in preferred embodiments four apertures may be provided.

Advantageously, the retaining member may assist in providing a safety mechanism in that if the second end of the metal tube is not sealed by the second end cap, for instance by a child inadvertently tampering with the invention, the retaining member may assist in maintaining the permeable separator sheet firmly folded over the top region of the powder mixture adjacent the second end. The powder mixture may not then be potentially ingested by a child, or, otherwise leaked out of the metal tube. Moreover, the aperture in the retaining member may enable liquid to also flow therethrough into contact with the powder mixture via the top of the powder mixture.

Preferably, the retaining member may include a three-dimensional configuration adapted for engaging with an o-ring such that the o-ring may be maintained in a substantially fixed position within the metal tube of the battery to alleviate leakage of the liquid from the metal tube of the battery in use. Typically, the three-dimensional configuration may include a recess, a channel or a groove for seating of the o-ring. Typically, the three dimensional configuration may be disposed along a periphery of the retaining member and typically on a side of the retaining member adapted for facing outwardly of the second end of the metal tube. Typically, the o-ring may be about approximately 0.5 mm in thickness whereby the pressure of the second end cap releasably sealing the second end of the metal tube may cause the o-ring, which is seated in the three-dimensional configuration of the retaining member, to be flattened and urged snugly against an inner surface of the outer casing so as to alleviate leakage via a gap between the metal tube and the inner surface of the outer casing.

In a second broad form, the present invention provides a battery including:

a metal tube having opposed first and second ends, the first end being substantially sealed by a first end cap and the second end being releasably sealable by a second end cap, and an inner peripheral surface defining a chamber in which a liquid-activatable powder mixture is disposed therein;

a permeable separator sheet disposed between the powder mixture and the inner peripheral surface for electrically isolating the powder mixture from the metal tube;

a conductive rod having a first end positioned outwardly of the first end of the metal tube via an aperture disposed in the first end cap, said first end extending to a second end which is embedded in the powder mixture; and

a groove formed in the inner peripheral surface of the metal tube extending between the first and second opposed ends to allow flow of liquid therethrough, wherein said liquid is able to be delivered from the groove into contact with the powder mixture via the permeable separator sheet substantially along the length of the metal tube so as to activate the powder mixture, whereby the activated powder mixture is adapted to generate a potential difference between the conductive rod and the metal tube.

In a third broad form, the present invention provides a method of activating a battery, the battery including:

a metal tube having opposed first and second ends, and an inner peripheral surface defining a chamber in which a liquid-activatable powder mixture is disposed therein;

a permeable separator sheet for electrically isolating the powder mixture from the metal tube;

a conductive rod having a first end located adjacent the first end of the metal tube and a second end embedded in the powder mixture; and

wherein, the method includes the steps of:
(i) delivering a liquid into the chamber; and
(ii) channelling the liquid along the passage, wherein said liquid is able to be delivered from the passage into contact with the powder mixture via the permeable separator sheet substantially along the length of the metal tube so as to activate the powder mixture, whereby the activated powder mixture is adapted to generate a potential difference between the conductive rod and the metal tube.

In a fourth broad form, the present invention provides a packaging including a compartment for releasably sealing a battery therein.

Preferably, the battery may include a battery formed in accordance with any one of the first and second broad forms of the present invention.

Preferably, the packaging compartment may be adapted to provide an air and/or liquid tight seal around the battery sealed therein. Preferably, releasable sealing of the battery within the compartment may take place within a humidity-controlled environment to alleviate moisture from being trapped within the compartment. Typically, the present invention may include a moisture absorbent material such as a gel pack adapted for absorbing at least some moisture from the compartment to alleviate premature activation of the battery therein.

Preferably, the packaging may include a plurality of packaging compartments arranged in a strip. Typically, the plurality of compartments may be substantially identical in shape and dimensions. Typically the strip may form a rectangular shape.

Preferably, the present invention may include a dispenser having an opening, the dispenser being configured for dispensing the packaging compartments incrementally from the opening. Typically, the dispenser may include a spool around which the strip may be wound.

Preferably at least a first and a second adjacent compartment may be separable from each other via a tear line disposed in the packaging material between the first and second adjacent compartments.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows an exploded perspective-view of a first embodiment water-activatable battery in accordance with the present invention;

FIG. 2(a) shows a perspective view of a zinc cylindrical metal tube of the first embodiment;

FIG. 2(b) shows a perspective cut-away view of the zinc cylindrical metal tube of the first embodiment;

FIG. 2(c) shows a side cut-away view of the zinc cylindrical metal tube of the first embodiment with grooves disposed in the inner peripheral surface of the metal tube visible;

FIG. 2(d) shows an end view of the zinc cylindrical metal tube of the first embodiment with the evenly spaced-apart grooves in the inner peripheral surface of the metal tube visible;

FIG. 3(a) shows a perspective view of a steel cylindrical outer casing which surrounds and reinforces the metal tube in the first embodiment;

FIG. 3(b) shows a perspective cut-away view of the steel cylindrical outer casing of the first embodiment;

FIG. 3(c) shows a perspective view of the steel cylindrical outer casing with the screw-thread region visible;

FIG. 4(a) shows a topological view of a second end cap adapted for releasably sellable attachment to the steel cylindrical outer casing of the first embodiment;

FIG. 4(b) shows a side cut-away view of the second end cap of the first embodiment;

FIG. 4(c) shows a side view of the second end cap of the first embodiment;

FIG. 4(d) shows a topological perspective view of the second end cap of the first embodiment;

FIG. 4(e) shows a bottom perspective view of the second end cap of the first embodiment;

FIG. 5(a) shows a bottom view of the retaining member of the first embodiment;

FIG. 5(b) shows a topological view of the retaining member of the first embodiment;

FIG. 5(c) shows a first topological perspective view of the retaining member of the first embodiment;

FIG. 5(d) shows a second topological perspective view of the retaining member of the first embodiment;

FIG. 6(a) shows a perspective view of an o-ring which is adapted for engagement in a three-dimensional seating configuration of the retaining member of the first embodiment;

FIG. 6(b) shows a side view of the o-ring shown in FIG. 6(a);

FIG. 7(a) shows a side view of an assembly comprising a plastic first end cap, steel contact and carbon stick, the carbon stick being adapted for contacting with the electrolyte powder mixture whilst the steel contact juts out of an aperture in the first end cap;

FIG. 7(b) shows a first perspective view of the assembly comprising a plastic first end cap, steel cap and carbon stick, the carbon stick being adapted for contacting with the electrolyte powder mixture whilst the steel contact juts out of an aperture in the first end cap;

FIG. 7(c) shows a second perspective view of the assembly comprising the plastic first end contact, steel contact and carbon stick, the carbon stick being adapted for contacting with the electrolyte powder mixture whilst the steel contact juts out of an aperture in the first end cap;

FIG. 7(d) shows a topological view of the first end cap;

FIG. 7(e) shows a bottom view of the first end cap; and

FIG. 8 shows a perspective view of a pre-formed permeable separator sheet comprising double-layered kraft paper used in accordance with the first embodiment; and

FIG. 9 shows an exemplary strip packaging for batteries such as batteries formed in accordance with the first embodiment.

### DETAILED DESCRIPTION

Preferred embodiments of the present invention will now be described with reference to the drawings. The exemplary embodiments described herein include water-activatable batteries suitable for use in complying with requirements of shape, dimensions and power output of off-the-shelf type AA and AAA batteries. However, it would be appreciated by a person skilled in the art that embodiments of the present invention may include other types of batteries having different shape and dimensions and electrical outputs comparable to conventional AAA type batteries and the like

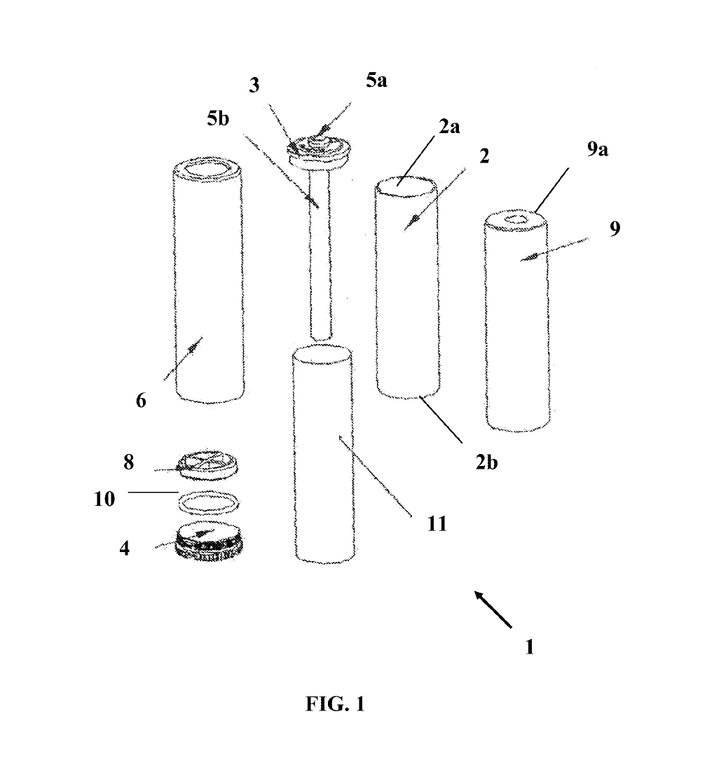

Turning firstly to FIG. 1 a first embodiment battery (1) is shown in exploded perspective-view. The battery (1) remains inactive until a liquid such as water or any other suitable water-based liquid is added to it and may, due to its initial inactive state, enjoy a shelf-life of considerably longer duration than conventional batteries intended for similar types of applications due to the tendency of such conventional type batteries to deteriorate almost immediately after manufacture. When water is delivered into contact with a powder mixture (11) disposed inside the battery, the powder mixture (11) becomes activated and generates a potential difference between electrically-isolated positive and negative electrodes of the battery which may then be used as an electrical power source for flashlights, radios, and other electronic devices. The features and operation of this embodiment will be described in detail as follows.

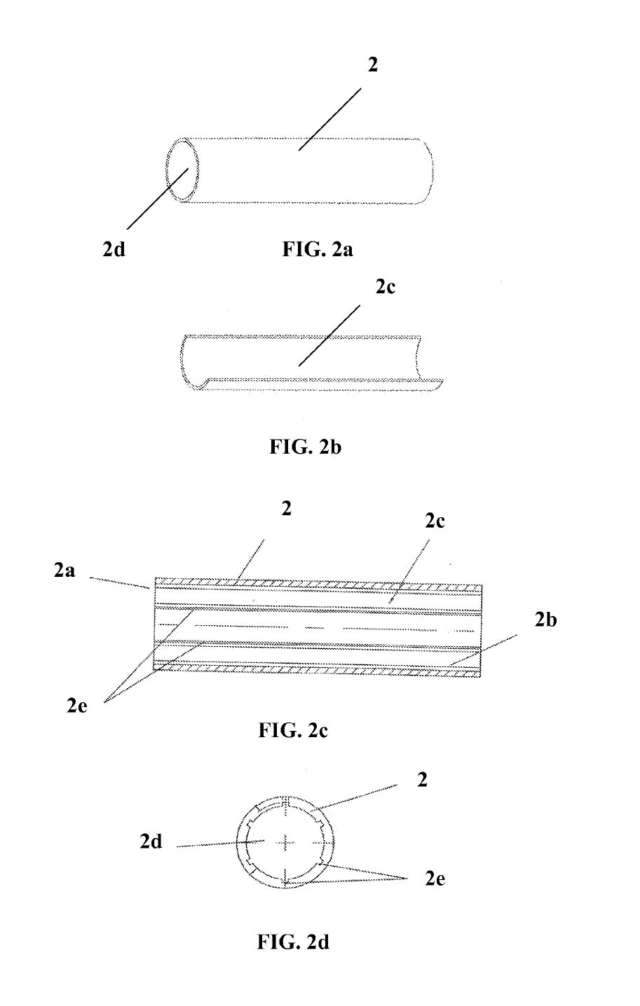

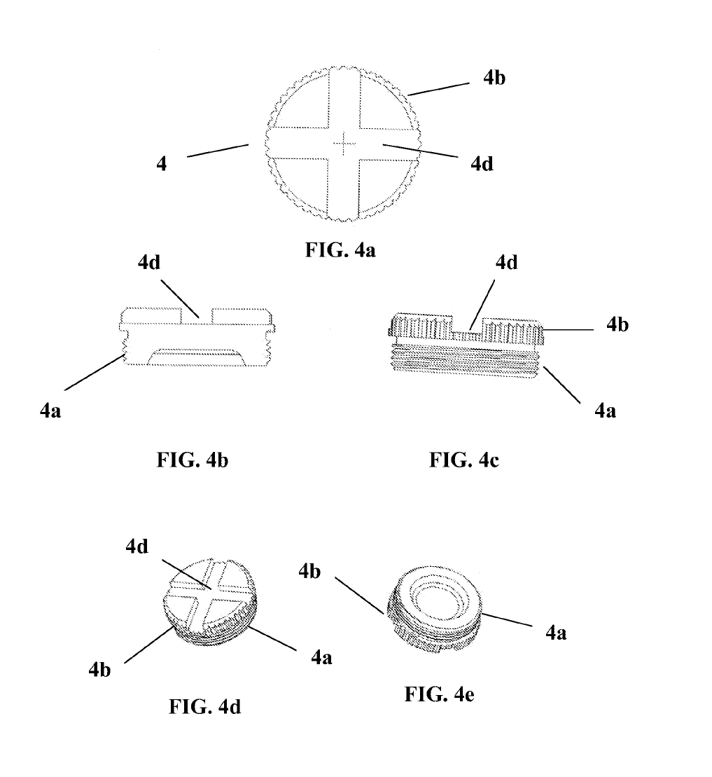

The battery (1) includes a cylindrical-shaped metal tube (2) having opposed first and second ends as shown in FIGS. 1 and 2(a)-(c). The first end (2a) of the metal tube is sealed by a disc-shaped first end cap (3) including an ABS material (3b) with an aperture (3a) disposed therein. The second end (2b) of the metal tube (2) is releasably sealable by a second end cap (4) which is adapted for screw-threaded engagement with a complementary screw-thread on an inner surface located at an end of the outer casing (6) surrounding the metal tube (2). The first and second end caps (3,4) are shaped to substantially complement the shape and dimensions of the first and second ends (2a,2b) of the metal tube (2). The first and second end caps (3,4) arc shown in FIGS. 1, 4(a)-(e) and 7(a)-(e) of the drawings.

The second end cap (4) is formed from a metallic material such as stainless steel such that when it is screwed in to sealing position adjacent the second end (2b) of the metal tube (2), the metal tube (2) and the second end cap (4) are in electrical communication. In this embodiment, when the second end cap (4) is releasably sealing the second end (2b) of the metal tube (2), the second end cap (4) is actually attached by screw-threaded engagement with a steel outer casing (6) which surrounds the metal tube (2). The steel outer casing (6) will be described in greater detail below. When the second end cap (4) is screwed on to the steel outer casing (6) it is also in direct physical contact with the second end (2b) of the metal tube (2) so as to enable electrical communication between the second end cap (4) and the metal tube (2) which together form a negative electrode of the battery in use.

Referring now to FIGS. 2(a)-(d), it can be seen that the metal tube (2) includes an inner peripheral surface (2c) which defines a chamber (2d) for storing the powder mixture (11). Six evenly spaced grooves (2e) are formed along the inner peripheral surface (2c) of the metal tube (2) which extend in substantially straight paths between the first and second ends (2a,2b) of the metal tube (2). The grooves (2e) are cut or etched out of the inner peripheral surface so as to be suitably sized and dimensioned to allow water to freely flow therethrough from the second end (2b) toward the first end (2a) of the metal tube (2). In certain embodiments it is possible to die-cast the metal tube (2) with the grooves formed therein.

The electrolyte powder mixture (11) in embodiments of the present invention includes a metal oxide powder such as manganese dioxide, iron oxide or crystalline silver oxide which substantially fills the chamber (2d) of the metal tube (2). In preferred embodiments, the powder mixture (11) includes approximately 3% ammonium chloride particles, 16% zinc chloride particles, 68% manganese dioxide particles, 12.4% acetylene carbon black particles and 0.6% zinc oxide particles by percentage weight of the powder mixture (11).

The powder mixture is ball-milled using a rotary or planetary ball mill and ceramic balls such as agate (carnelian). During testing, a laboratory ball-milling machine of 500 ml volume was used with ceramic milling balls weighing 110 g and having diameters of 22.4 mm, or, small sized balls weighing 190 g weight and having diameters of 10.0 mm. Also during testing, 150 g of powder mixture was milled on each occasion. It would be understood that the ball milling of the powder mixture can be suitably scaled up to industrial size to accommodate much larger production.

Powder mixture particles resulting from the ball-milling included diameters in the nanometre to micrometre range. In preferred embodiments, the diameters of the powder mixture particles is around 4.32 micrometres.

In certain embodiments, after the permeable separator sheet (9) has been positioned to line the inner peripheral surface (2c) of the metal tube (2), the powder mixture (11) is deposited by a machine into the chamber (2d) of the metal tube (2). Thereafter the metal tube may be shaken to more uniformly distribute the powder mixture (11) within the chamber (2d). A plunger may then be used to compress the powder mixture (11). These steps may be repeated one or more times if necessary to assist in maximising the amount of powder mixture in the chamber (2d) of the metal tube (2).

The powder mixture (11) is substantially physically and electrically isolated from the inner peripheral surface (2c) of the metal tube (2) by the permeable separator sheet (9). The permeable separator sheet includes a double-layer of 0.08 mm Kraft paper. A single sheet of kraft paper could be doubled-over to serve this purpose. An outer surface of the permeable separator sheet (9) lies flush against the inner peripheral surface (2c) of the metal tube (2) whilst an inner surface contacts with the powder mixture (11) in the metal tube (2).

Whilst the permeable separator sheet (9) is made from a permeable paper, a synthetic or natural polymer material could be used in alternative embodiments.

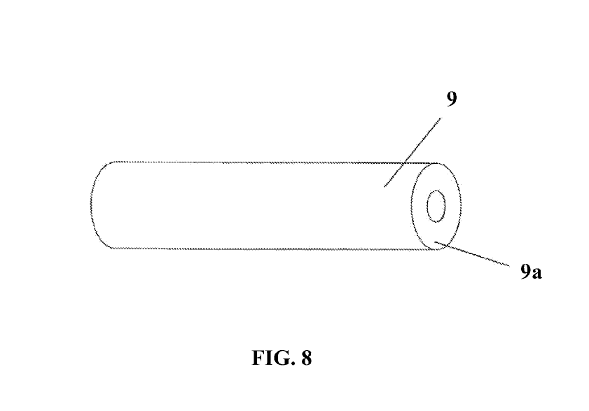

Conveniently, the permeable separator sheet (9) enables wicking of the liquid therethrough and into contact with the powder mixture (11) in use without unduly retaining the liquid as is the case with sponge-like materials. As shown in FIG. 8, an end portion (9a) of the permeable separator sheet (9) is folded over against a to region of the powder mixture (11) adjacent the second end (2b) of the metal tube (2) to assist in keeping any loose powder mixture (11) from leaking out of the second end (2b) of the metal tube (2) when unsealed.

The battery (1) also includes a conductive rod (5) having a first end consisting of a steel contact (5a) and a second end consisting of a carbon stick (5b). The carbon stick (5b) extends inwardly of the metal tube (2) from the first end (2a) of the metal tube (2) substantially towards the second end (2b) of the metal tube (2) and is embedded within the powder mixture (11). The steel contact (5a) coupled to the carbon stick (5b) juts outwardly of the first end (2a) of the metal tube (2) via an aperture (3a) in the first plastic end cap (3). The conductive rod (5) is electrically isolated from the metal tube (2) and the metal second end cap (4). When assembling the embodiment battery, the conductive rod (5) consisting of the steel contact (5a) and carbon stick (5b) can be manoeuvred inwardly of the metal tube (2) in a direction from the opened second end (2b) towards the first end (2a) until the steel contact (5a) juts out of the aperture (3a) of the plastic first end cap (3). The aperture (3a) is sized to prevent the conductive rod (5) from being able to pass entirely through the aperture (3a).

The diameter of the aperture (3a) in the first end cap (3) is designed to be snug-fitting with the diameter of the steel contact (5a) so as to alleviate escape of any loose powder mixture (11) adjacent the first end (2a) of the metal tube (2). An o-ring is disposed between the first end cap (3) and the first end (2a) of the metal tube (2) for sealing purposes.

When the battery (1) is in operation, the conductive rod (5) acts as a positive electrode of the battery (1) to which positive ions produced as a result of the chemical reaction at the metal tube (2) will flow to via the permeable separator sheet (9) and powder mixture (11).

In order to activate the battery (1), the second end cap (4) is unscrewed from the steel outer casing (6) to allow water to be delivered into the metal tube (2) into contact with the powder mixture. In seeking to obtain optimal electrical performance, it is preferable to submerge the entire unsealed battery within a glass of purified or distilled water for at least 5 minutes so that the water may enter via the unsealed second end (2b) of the metal tube, flow substantially along the lengths of the grooves (6e) in the inner peripheral surface (2c) of the metal tube (2) and then flow into contact with the powder mixture from the grooves (6e) via the permeable separator sheet (9). This will assist in allowing the water to more thoroughly flow through the grooves in the inner peripheral surface (2c) of the metal tube (2). However, if the battery embodiment is not fully submerged in water, it is possible to activate the powder mixture (11) by scooping or pouring at least about 1.7 grams of water into the unsealed second end (2b) of the metal tube (2) before resealing the second end cap (4) to the second end (2b) of the metal tube (2).

Water flows from the grooves (2e) substantially along an entire length of the battery (1) and through the permeable separator sheet (9) due to its wicking effect and then into contact with the powder mixture (11). In alternative embodiments, the grooves may include curved paths to further increase the amount of contact the water may have with the powder mixture (11). As would be appreciated, the surface area of powder mixture (11) which the water is able to contact with and penetrate into is considerably greater than in the case of prior art water-activatable batteries which requires water to penetrate the powder mixture only at the top surface of the powder mixture (11).

Once the second end cap (4) has been screwed back onto the steel outer casing (6) to releasably seal the second end (2b) of the metal tube (2), the battery (1) is activated and ready for use in powering electronic devices. In certain embodiments it is conceivable that water may be injected into the chamber (2d) under pressure by use of a pipette inserted into a relatively smaller opening in a sealed second end (2b) of the metal tube (2). However, this option is less preferable given the need for an additional pipette to squirt water into the metal tube and the lack of visual indication to assist in determining whether the battery (1) has been injected with an appropriate amount of water.

Once water has contacted with the powder mixture (11), the powder mixture (11) chemically reacts with the metal tube (2) whereby a potential difference is generated between the positive electrode consisting of the conductive rod (5), and, the negative electrode consisting of the combination of the second end cap (4) and the metal tube (2). Whilst the permeable separator sheet (9) disposed between the positive electrode (i.e. the conductive rod) and the negative electrode (i.e. the metal tube and second end cap) of the battery (1) physically and electrically isolates the positive and negative electrodes of the battery, it also allows for free flow of positive ions created as a result of the chemical reactions from the negative electrode metal tube (2) towards the positive electrode in use so as to continue to generate and maintain the potential difference. Electrons formed at the negative electrode are therefore able to flow from the negative electrode through a load device and back to the positive electrode of the battery (1).

In the preferred embodiments, the metal tube (2) is formed from at least 99% zinc by percentage weight of the metal tube (2). The use of zinc material in the metal tube (2) will result in a relatively less energetic chemical reaction within the battery (1) and this assists in extending the operational lifespan after activation of the battery as the zinc material in the metal tube (2) takes longer to corrode in use than conventional batteries such as those using magnesium metal tubes. The zinc metal tube (2) is additionally bathed in indium to alleviate corrosion. In alternative embodiments the metal tube (2) could be formed substantially from magnesium, aluminium or any combination thereof. However, the use of magnesium to form the metal tube (2) could give rise to a relatively vigorous chemical reaction within the battery (1) which tends to shorten the operational lifespan of the battery (1) after activation due to faster depletion of the magnesium metal tube (2).

The use of a zinc metal tube (2) will also provide a relatively lower but more controlled and conventional electrical output over a relatively longer lifespan upon activation compared to use of a magnesium metal tube (2) which will provide a relatively higher output power over a relatively shorter lifespan upon activation. Use of a magnesium metal tube may also result in an unconventional 2.1V initial voltage which may cause damage to products if used in serial. Typically, if the metal tube (2) is formed from magnesium it is expected that the usable lifespan of such embodiments may last for approximately 2-3 weeks after activation whilst the usable lifespan of embodiments using zinc as the metal tube (2) may last for approximately 6-12 months after activation. It is conceivable that in yet alternative embodiments of the present invention, a sacrificial anode may be included in the battery which serves to slow down the corrosion of the metal tube material.

When the potential difference across the battery (1) falls to an unusable level, water can be re-filled in to the battery (1) as described above to reactivate the powder mixture (11) and to again generate a usable potential difference across the positive and negative electrodes of the battery (1).

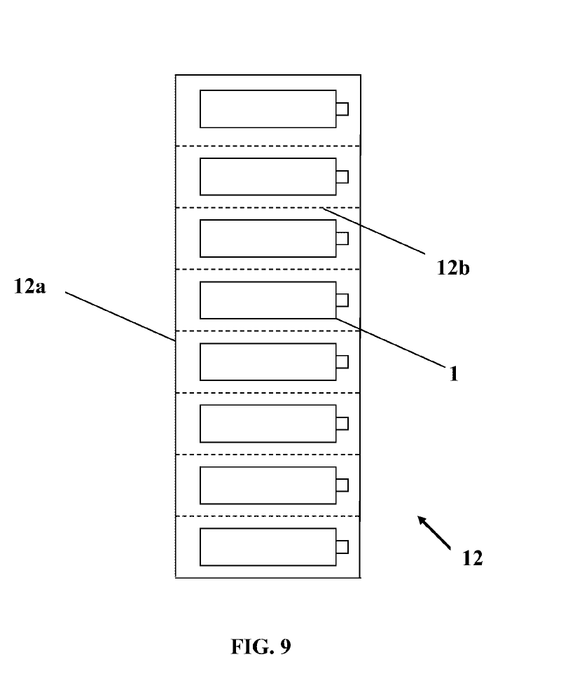

As mentioned above, a steel outer casing (6) surrounds the metal tube (2) as a reinforcement for the metal tube (2) against deformation due to heat and other stresses typically arising during use. In this embodiment the steel outer casing (6) is adapted to slide over the metal tube (2) as a snug-fitting outer sleeve. As shown in FIG. 9, the outer casing (6) is folded over the first end (2a) of the metal tube (2) and over a peripheral edge of the first end cap (3) so as to prevent the metal tube and first end cap from being ejected from that end of the outer casing (6). The opposing end of the outer casing (6) having the screw threads (6a) located thereon is not folded over the second end (2b) of the metal tube (2) so as not to prevent ejection of the metal tube (2) from that end of the outer casing (6) during separation for recycling purposes as discussed further below.

Where the outer casing (6) is a metal material, it will be in electrical communication with the metal tube (2) as an inner peripheral surface of the outer casing surrounds and snugly abuts against the outer peripheral surface of the metal tube (2) so as to facilitate electrical communication therebetween.

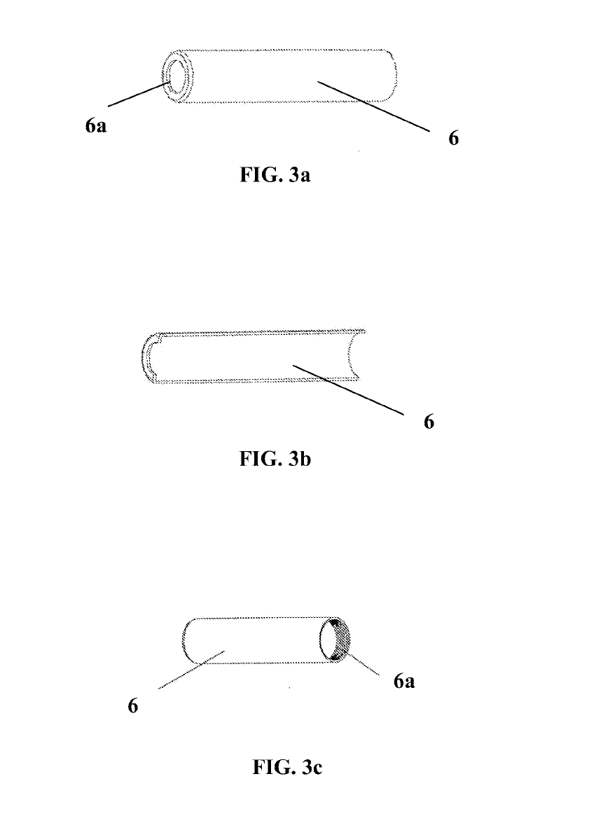

The outer casing (6) includes internal screw-threads (6a) as shown in FIG. 3(c) for releasable engagement with a complementary screw-thread arrangement (4a) disposed on the second end cap (4) as shown in FIGS. 4(b)-(e). The second end-cap (4) includes a cross-shaped indent (4d) disposed on its outward-facing surface to enable a screw-driver head, coin or finger nail to screw or unscrew the second end cap (4) to or from the steel outer casing (6). The second end cap (4) also includes ridges (4b) arranged around a peripheral edge which can be gripped by a user's fingers to unscrew the second end cap (4) from the outer casing (6).

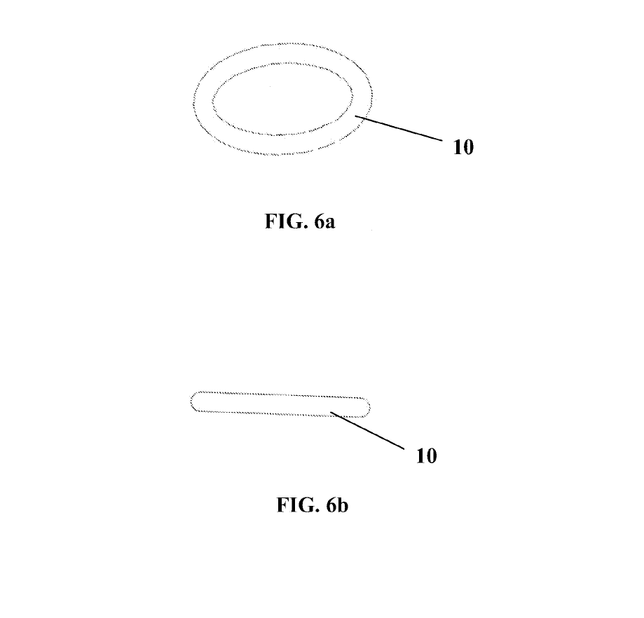

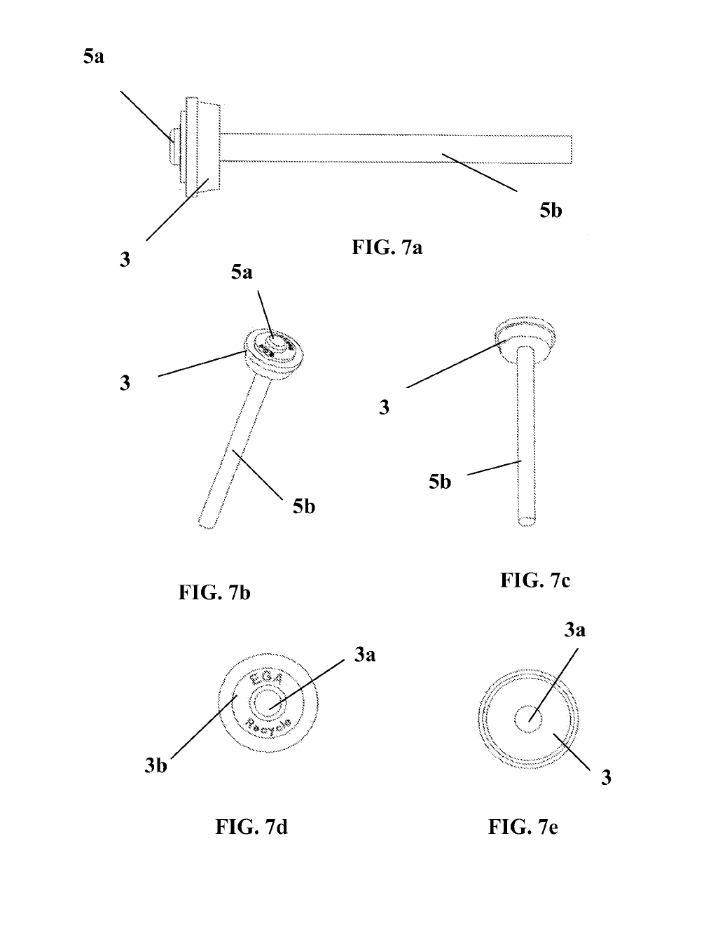

In certain embodiments, a plastic outer casing (6) may be used. The plastic outer casing could be preformed and/or moulded to fit snugly around the metal tube (2). If a plastic outer casing (6) is used, it would be desirable to ensure that the second end cap (4) is firmly screwed inwardly of the plastic outer casing (6) and into contact with the second end (2b) of the metal tube (2) so that they are electrically connected and the second end cap (4) and metal tube (2) functions as the negative electrode in use. In certain embodiments the screw thread portion (6a) of the plastic outer casing (6) is covered with a conductive material to assist in providing the electrical communication between the second end cap (4) and the metal tube (2). Advantageously, an outer surface of a plastic outer casing (6) may be relatively easily debossed and/or decorated with branding and/or other commercial indicia. Also, a plastic outer casing may be desirable due to its relatively lighter weight which saves costs during shipping of disassembled plastic outer casings hack to a factory for re-usage in the manufacture of new batteries.

Where a metal outer casing (6) is used, the second end cap (4) provides electrical communication between the second end cap (4) and the metal tube (2) without the second end cap (4) necessarily being in direct contact with the metal tube (2). The second end cap (4) should still be firmly screwed into releasable engagement with the outer casing (6) such that the pressure is placed upon the o-ring (10) as shown in FIG. 6a and FIG. 6b to assist in keeping it in a substantially stationary position whereby it alleviates leakage of liquid between a gap between the zinc metal tube (2) and an inner surface of outer casing (6).

In alternative embodiments where no outer casing is used, the second end cap (4) could be releasably engaged by screw-thread engagement or any other suitable attachment means directly to the second end (2b) of the metal tube (2).

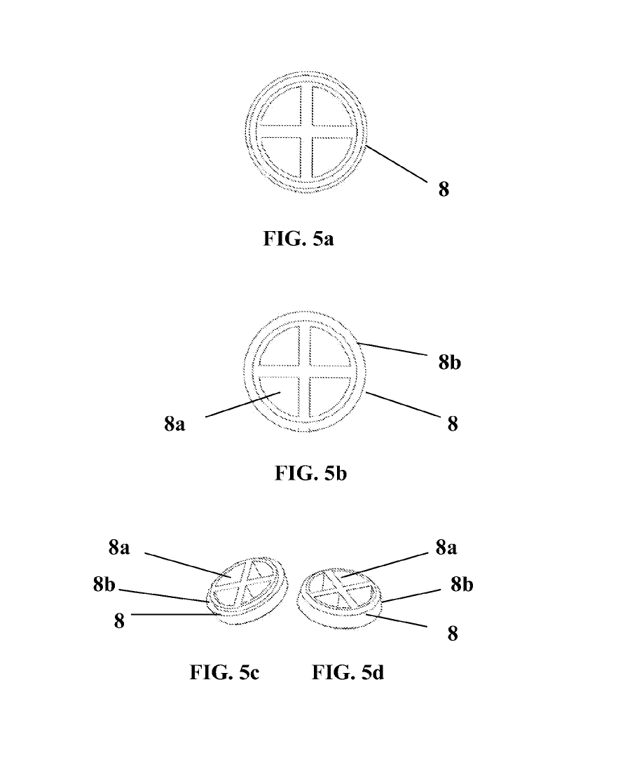

Turning to FIGS. 5(a)-(d), a plastic circular-shaped retaining member (8) is shown which is adapted to sit upon the folded over portion (9a) of the permeable separator sheet (9) which encloses the top portion of the electrolyte powder mixture (11) adjacent the second end (2b) of the metal tube (2). The retaining member (8) includes a cylindrical cross-section of similar diameter to that of the second end (2b) of the metal tube (2) such that it fits snugly inside the second end (2b) of the metal tube (2).

The retaining member (8) also includes four segment-shaped apertures (8a) passing entirely through from one side to the other. Advantageously, the retaining member (8) not only assists in holding the folded over portion (9a) of the permeable separator sheet (9) in place to keep loose powder mixture (11) from escaping via the second end (2b) of the metal tube (2), but it also allows water to flow through it into contact with the powder mixture (11) via the folded over portion (9a) of the permeable separator sheet (9). When water is delivered into the unsealed second end (2b) of the metal tube (2), not only will water flow along the length of the metal tube (2) via the grooves (2e) in the inner peripheral surface (2c) of the metal tube (2), but some water may also flow through the apertures (8a) in the retaining member (8) and into contact with the powder mixture (11) via the top of the powder mixture (11) covered by the folded over portion (9a) of the permeable separator sheet (9). It should be noted that in certain alternative embodiments, the water may first pass through the apertures (8a) of the retaining member (8) before the water flows into and along the grooves (2e) in the inner peripheral surface of the metal tube (2).

Also as mentioned above, the retaining member (8) includes a three-dimensional configuration (8b) adapted for engaging with another o-ring (10). As such the three dimensional configuration includes a seat extending around a periphery of the retaining member (8) on an outward-facing side of the retaining member (8). The o-ring (10) is about approximately 0.5 mm in thickness whereby the pressure of the second end cap (4) releasably sealing the second end (2b) of the metal tube (2) causes the o-ring (10), which is seated in the three dimensional configuration (8b) of the retaining member (8), to be flattened and urged snugly against an inner surface of the outer casing (6) so as to alleviate leakage via a gap between the metal tube (2) and the inner surface of the outer casing (6).

It would be appreciated that during operation of the battery (1) corrosion of the metal tube (2) tends to result in waste products building up at the metal tube (2) which may at least partially occlude liquid-flow via the grooves (2e) over time. In this regard, the ability of the retaining member (8) to allow water to pass through it and into contact with the top surface of the powder mixture (11) is advantageous.

Embodiments of the present invention are assembled in a humidity controlled environment, commonly referred to as a “dry room” to alleviate risk of moisture activating the powder mixture (11) and thereby corrupting operation of the batteries.

In addition to the actual battery embodiments being assembled in a humidity controlled environment, the battery embodiments are also packaged within a humidity-controlled environment in order to alleviate risk of excess moisture being trapped within the packaging.

In a preferred embodiment as depicted in FIG. 9, the packaging (12) includes a plurality of substantially identical compartments (12a) forming a strip. Each of the compartments (12a) provides liquid and air-tight sealing around a battery (1) formed in accordance with the first embodiment. The compartments (12a) are formed from an environmentally-friendly transparent plastic material. The compartments (12a) could for instance be formed by using suitable machinery to heat seal the plastic material around the batteries (1).

Each of the compartments (12a) of the packaging (12) can be separated from each other by tearing along a tear-line (12b).

Advantageously, embodiments of the present invention have been engineered to comply with the physical parameters of standard AA, AAA type batteries and the like suitable for use in flashlights, radios, mobile phones etc, whilst at the same time providing an output performance suitable for powering such devices. By way of example, AA-type battery embodiments of the present invention involving the use of a zinc metal tube have been found to produce an electrical output of 4500-5000 mA short circuit (maximum amp) at 1.7V and with 25 mA constant current drain achieve an mAh of around 600-700 which is an electrical output comparable to the electrical output of conventional AA-type batteries used in similar applications.

Tests have been carried out in respect of embodiments of the present invention using different electrolyte powder mixture compositions to assess their effect upon electrical performance.

A first powder composition comprising of approximately 60% manganese oxide, 3% ammonium chloride, 16% zinc chloride, 0.6% zinc oxide and 20% acetylene carbon black by percentage weight of the powder mixture was used in a tested embodiment. With a relatively lower amount of manganese oxide and relatively higher amount of acetylene carbon black in the electrolyte powder mixture, an initial voltage of 1.62V and maximum or short circuit Amp of 1.75 A resulted in electrical output of 250 mAh (based on 200 mA constant current drain with 0.9V cut-off). With an initial voltage of 1.61V and maximum or short circuit Amp of 2.05 A resulted in electrical output of 254 mAh (based on 200 mA constant current drain with 0.9V cut-off).

A second powder composition comprising of approximately 71% manganese oxide, 3% ammonium chloride, 16% zinc chloride, 0.6% zinc oxide and 9.2% acetylene carbon black by percentage weight of the powder mixture was used in a tested embodiment. With a slightly higher amount of manganese oxide and slightly lower amount of acetylene carbon black in the electrolyte powder mixture, an initial voltage of 1.65V and maximum or short circuit Amp of 1.62 A resulted in electrical output of 280 mAh (based on 200 mA constant current drain with 0.9V cut-off). With an initial voltage of 1.64V and maximum or short circuit Amp of 1.53 A resulted in electrical output of 279 mAh (based on 200 mA constant current drain with 0.9V cut-off).

A third powder composition comprising of approximately 68% manganese oxide, 3% ammonium chloride, 16% zinc chloride, 0.6% zinc oxide and 12.4% acetylene carbon black by percentage weight of the powder mixture was used in a tested embodiment. An initial voltage of 1.75V and maximum or short circuit Amp of 3.78 A resulted in electrical output of 368 mAh (based on 200 mA constant current drain with 0.9 V cut-off). With an initial voltage of 1.75V and maximum or short circuit Amp of 3.3 A resulted in electrical output of 375 mAh (based on 200 mA constant current drain with 0.9V cut-off). This powder composition was considered to provide the best electrical performance from embodiments of the present invention tested.

Advantageously, a liquid-activated battery in accordance with embodiments of the present invention provides a relatively longer shelf-life than conventional batteries given that they only become active upon addition of a liquid to the powder mixture therein. In contrast, conventional batteries tend to deteriorate immediately upon manufacture and may not be usable after a relatively shorter duration of time in storage. Whilst embodiments of the present invention described herein are particularly well-suited for and intended for use during emergency situations due to the longer shelf-life, the actual output performance of such battery embodiments can be comparable or superior to the power output expected of certain conventional batteries.

Also advantageously, the mechanical design of embodiments of the present invention assists in providing ease of reusability and recyclability of the component parts. For instance, after unscrewing the second end cap (4) from the steel outer casing (6), the retaining member and o-ring can be readily dislodged from the metal tube (2), and then the conductive rod (5) and first end cap (3) can then be punched out of the outer casing (6) via the second end (2b) of the metal tube (2) followed by removal of the permeable separator sheet (9). The metal tube (2) will also be readily separable from the steel outer casing (6) via the end of the steel outer tube (6) which is not folded over the second end of the metal tube (2b). The separation of the component parts can be performed manually by hand, by use of an automated machine or a combination thereof.

Thereafter, the outer casing, second end cap (4), and conductive rod may be collected and returned to a factory for re-use in the manufacture of new batteries instead of incurring time, costs and energy in recycling such parts. Further cost savings may be obtained by collecting these re-usable component parts and shipping them in bulk to a factory in a relatively cost-effective manufacturing jurisdiction.

In embodiments where a plastic outer casing is used, the relatively lighter weight of the plastic compared to metal may further alleviate the costs of shipping the outer casings back to the factory for re-use, particularly where the shipping is over a relatively long distance. It is also understood that a plastic outer casing may be easier to re-use or recycle as there is typically no bonding or fusing involved with the zinc metal tube which facilitates relatively easy separation from the zinc metal tube (2) before shipping back to the factor for re-use.

The zinc metal tube, the permeable separator sheet and the plastic first end cap can be recycled in a relatively expedient and energy-efficient manner compared to the recycling of conventional batteries. That is, conventional batteries must first be shredded and then furnaced with various materials being recouped at different temperatures. Shredding is not required as the zinc metal tube (2) can be easily separated from the outer casing (6). Also, as the melting temperature of a zinc metal tube tends to be lower than that of the metal tube of conventional batteries, less energy is expended during recycling of the zinc tube.

In addition to the advantages outlined above, embodiments of the present invention also have been tested and found to satisfy the requirements of the Restriction on the Use of Hazardous Substances in Electrical and Electronic Equipment Directive 2002/95/EC (ROHS). Accordingly, battery embodiments are considered to provide an environmentally-friendly alternative to prior art batteries due to the high percentage of the component parts that may be recycled/reused in compliance with the ROHS Directive.

Furthermore, embodiments of the present invention have been tested and found to satisfy the requirements of Article 4(1) of Directive 2006/66/EC and EN 71 Part 3 relating to the mercury content of the batteries. It has been found that the embodiments do not contain levels of mercury exceeding the prescribed limits and are therefore considered safe for human usage.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A battery including:
a metal tube having opposed first and second ends, and an inner peripheral surface defining a chamber in which a liquid-activatable powder mixture is disposed therein;
a permeable separator sheet for electrically isolating the powder mixture from the metal tube;
a conductive rod having a first end located adjacent the first end of the metal tube and extending to a second end in contact with the powder mixture; and
a passage extending between the first and second opposed ends of the metal tube to allow flow of liquid therethrough, wherein said liquid is able to be delivered from the passage into contact with the powder mixture via the permeable separator sheet substantially along the length of the metal tube so as to activate the powder mixture, whereby the activated powder mixture is adapted to generate a potential difference between the conductive rod and the metal tube.

2. A battery as claimed in claim 1 wherein the metal tube includes at least one of zinc, magnesium, aluminium, and a combination thereof.

3. A battery as claimed in claim 2 wherein the metal tube includes at least approximately 99% zinc by percentage weight of the metal tube.

4. A battery as claimed in claim 3 wherein the metal tube is bathed in indium.

5. A battery as claimed in claim 1 wherein the first end of the metal tube is substantially sealed by a first end cap including a plastic material.

6. A battery as claimed in claim 5 wherein the second end of the metal tube is releasably sealable by a second end cap, said second end of the metal tube being adapted to allow delivery of the liquid therethrough into the chamber when unsealed.

7. A battery as claimed in claim 6 wherein the second end cap and the second end of the metal tube include substantially similar diameters.

8. A battery as claimed in claim 6 wherein the second end cap includes a metal material adapted for electrical communication with the metal tube when releasably sealing the second end of the metal tube.

9. A battery as claimed in claim 5 wherein the first end of the conductive rod extends outwardly of the first end of the metal tube via an aperture disposed in the first end cap.

10. A battery as claimed in claim 1 wherein the second end of the conductive rod is substantially embedded within the powder mixture.

11. A battery as claimed in claim 1 wherein the conductive rod includes at least one a brass, a carbon and stainless steel.

12. A battery as claimed in claim 1 wherein the passage extends an entire length of the metal tube.

13. A battery as claimed in claim 12 wherein the passage extends in a substantially straight path between first and second opposed ends of the metal tube.

14. A battery as claimed in claim 13 wherein the passage extends in a substantially parallel path relative to an elongate axis of the metal tube.

15. A battery as claimed in claim 1 wherein the passage includes a curved path.

16. A battery as claimed in claim 1 wherein the passage includes a groove formed in the inner peripheral surface of the metal tube.

17. A battery as claimed in claim 16 including at least six grooves formed in the inner peripheral surface of the metal tube.

18. A battery as claimed in claim 17 wherein the at least six grooves are evenly spaced apart around the inner peripheral surface.

19. A battery as claimed in claim 1 wherein the liquid includes water or any water-based liquid.

20. A battery as claimed in claim 1 including an outer casing surrounding the metal tube which is adapted to substantially reinforce the metal tube against deformation.

21. A battery as claimed in claim 20 wherein the outer casing includes at least one of a metallic or a plastic material.

22. A battery as claimed in claim 21 wherein the metallic material includes stainless steel.

23. A battery as claimed in claim 20 wherein the outer casing includes a thickness of between approximately 0.2 to 1 mm.

24. A battery as claimed in claim 6 wherein the second end cap is adapted for screw-fitting engagement with the outer casing in order to releasably seal the second end of the metal tube whereby the second end cap is in electrical communication with the metal tube.

25. A battery as claimed in claim 1 wherein the powder mixture includes a metal oxide powder.

26. A battery as claimed in claim 25 wherein the metal oxide powder includes at least one of manganese dioxide, iron oxide, or crystalline silver oxide.

27. A battery as claimed in claim 25 wherein the powder mixture particles includes approximately 3% ammonium chloride particles, 16% zinc chloride particles, 68% manganese dioxide particles, 12.4% acetylene carbon black and 0.6% zinc oxide particles by percentage weight of the powder mixture particles.

28. A battery as claimed in claim 25 wherein the powder mixture includes particles of substantially around 4.32 micrometres in diameter.

29. A battery as claimed in claim 1 wherein the permeable separator sheet includes at least one of a permeable paper material, a permeable synthetic polymer material, and a permeable natural polymer material.

30. A battery as claimed in claim 1 including a double-layered sheet of 0.08 mm thickness Kraft paper.

31. A battery as claimed in claim 1 wherein the permeable separator sheet lies flush against the inner peripheral surface of the metal tube.

32. A battery as claimed in claim 1 wherein a portion of the permeable separator sheet is folded over the powder mixture adjacent the second end of the metal tube.

33. A battery as claimed in claim 32 including a retaining member disposed in the chamber adjacent the second end of the metal tube which abuts against the folded over portion of the permeable separator sheet.

34. A battery as claimed in claim 33 wherein the retaining member includes at least one aperture to allow fluid communication therethrough from the second end of the metal tube into contact with the folded over portion of the permeable separator sheet.

35. A battery as claimed in claim 33 wherein the retaining member includes a three-dimensional configuration adapted for engaging with an o-ring such that the o-ring is able to be maintained in a substantially stationary position adjacent the sealed second end cap so as to alleviate liquid leakage from the metal tube.

36. A battery as claimed in claim 1 including shape and dimensions of at least one of a AA-type and a AAA-type battery.

37. A method of activating a battery, the battery including:
a metal tube having opposed first and second ends, and an inner peripheral surface defining a chamber in which a liquid-activatable powder mixture is disposed therein;
a permeable separator sheet for electrically isolating the powder mixture from the metal tube;
a conductive rod having a first end located adjacent the first end of the metal tube and a second end embedded in the powder mixture; and
wherein, the method includes:
(i) delivering a liquid into the chamber; and
(ii) channelling the liquid along the passage, wherein said liquid is able to be delivered from the passage into contact with the powder mixture via the permeable separator sheet substantially along the length of the metal tube so as to activate the powder mixture, whereby the activated powder mixture is adapted to generate a potential difference between the conductive rod and the metal tube.
